(19) United States
(12) Patent Application Publication
(10) Pub. No.: US 2023/0375140 A1
(43) Pub. Date: Nov. 23, 2023

(54) VESSEL CONNECTION

(71) Applicant: ROLLS-ROYCE PLE, London (GB)

(72) Inventor: Daniel CLARK, Derby, Derbyshire (GB)

(21) Appl. No.: 18/246,808

(22) PCT Filed: Aug. 24, 2021
(86) PCT No.: PCT/EP2021/073364

§ 371 Date: Mar. 27, 2023

(30) Foreign Application Priority Data
Oct. 1, 2020 (GB) 2015582.6

(51) Int. Cl. F17C 13/00

(52) U.S. Cl. CPC F17C 13/002; F17C 2205/0352; F17C 2209/232

(57) ABSTRACT

There is disclosed a vessel connection (220) for a metallic pressure vessel comprising: a wall portion (221) configured to form a portion of a vessel wall; a pipe extension (222) integrally formed with the wall portion; and a channel (223) through the wall and the pipe extension. There is also disclosed a method of designing a canister for forming a vessel connection.

### FIELD OF DISCLOSURE

The present disclosure relates to a vessel connection for a pressure vessel, such as a liquid or gas-retaining vessel of an industrial plant, such as a power plant.

### BACKGROUND

An example conventional vessel 10 for an industrial plant is shown in FIG. 1. It has metal walls and is in the form of a cylinder with one or more hemi-spherical ends. Pipework 16, 18 extends between the vessel 10 and other vessels 12, 14 or components of the plant. Such pipework is conventionally attached to the vessel by welding an end of a pipe to the vessel wall so that the pipe extends along a direction normal to the vessel wall. An opening at the vessel wall may be machined before or after attaching the end of the pipe. Pipework between two vessels may include one or more mitre joints between joined lengths of pipe so as to approach the vessels from a suitable angle (an angle normal to the vessel wall). Such arrangements may limit the layout of the vessels and other plant equipment so as to limit the number of joints and provide suitable access to the pipework for maintenance and any instrumentation and modelling.

It is desirable to reduce such restrictions as to vessel layout and pipework design.

### SUMMARY

According to a first aspect of the disclosure there is disclosed a vessel connection for a metallic pressure vessel comprising: a wall portion configured to form a portion of a vessel wall; a pipe extension integrally formed with the wall portion; and a channel through the wall and the pipe extension.

The pipe extension may extend from the wall portion along a direction which is oblique relative to a normal direction of the wall portion.

The wall portion may be substantially planar or may be configured to form a portion of a cylindrical or domed (e.g. spherical) or conical part of a vessel.

The pipe extension may have a convoluted profile such that a central path of the pipe extension along which it extends describes a three-dimensional curve.

The wall portion may have an internal side corresponding to an interior of the vessel and an opposing external side corresponding to an exterior of the vessel. The pipe extension may extend from the external side by an amount equal to at least five times the diameter of the pipe extension at a junction with the wall portion.

The wall portion may have an internal side corresponding to an interior of the vessel and an opposing external side corresponding to an exterior of the vessel. The pipe extension may comprise an external portion extending from the external side and an internal portion extending from the internal side. The internal portion may meet the wall portion at a junction. A cross-section of the internal portion may expand away from the wall.

The cross-section of the internal portion is intended to refer to a cross section normal to a central path of the pipe extension along which it extends (i.e. normal to a local portion of the central path). Owing to the expanding cross-section, it would not be possible to withdraw the pipe extension from the wall portion if the pipe extension were separate from the wall portion.

The expanding internal portion may be configured to provide an opening to the pipe extension on the internal side of the vessel which is larger than the internal cross-section of the pipe extension at the junction with the wall portion. This may provide improved inlet or outlet flow conditions to or from the internal portion of the pipe relative to a pipe extension having a smaller opening. Since pipes are conventionally mounted to vessels by forming an opening in the vessel corresponding to the diameter of the pipe and welding the pipe from the outside, it is not possible with such pipes to have an expanding internal portion of the pipe on the interior of the vessel.

The vessel connection may further comprise an instrumentation port formed in the wall portion for insertion of a sensor into the vessel.

The instrumentation port may comprise a mount for the sensor and an opening for cabling to the sensor. The mount may be extend from an external side of the wall portion and define a sensor cavity configured to communicate with an interior of the vessel through an opening in the wall portion at the location of the mount.

There may be a plurality of pipe extensions, and there may be one or more channels extending through one or more respective pipe extensions.

Each pipe extension of the plurality may have any of the features of the pipe extension described above.

The wall portion may have an external side corresponding to an exterior of the vessel. Each of the pipe extensions may extend from a junction with an external side of the wall portion to a distal end for attachment to a separate pipe or vessel. A spacing between two pipe extensions may increase as they extend away from the wall portion, such that the two pipe extensions are spaced apart by a greater distance at their distance ends than at the respective junctions with the wall portion.

At least one of the pipe extensions may be closed at a respective junction with the wall portion to prevent fluid flow through the wall portion via the pipe extension.

The vessel connection may be formed as a unitary structure by hot isostatic pressing.

According to a second aspect of the disclosure there is provided a vessel installation comprising: a vessel having a wall comprising a vessel connection in accordance with the first aspect.

A first pipe extension of the vessel connection may be open at a respective junction with the wall portion for fluid communication between the vessel and a second component of the installation. A second pipe extension of the vessel connection may be closed at the respective junction with the wall portion to prevent fluid communication along the second pipe extension.

According to a third aspect of the disclosure there is disclosed a method of designing a canister for forming a vessel connection for a metallic pressure vessel, comprising:
providing a vessel connection model defining a vessel connection comprising:
   a wall portion corresponding to a portion of a vessel wall;
   a plurality of pipe extensions integrally formed with the wall portion;
modifying the vessel connection model to remove or truncate at least one of the pipe extensions from the vessel connection, thereby providing a modified vessel connection model defining a modified vessel connection;
defining a production canister model of a canister for forming the modified vessel connection by hot isostatic pressing.

According to a fourth aspect of the disclosure there is disclosed a method of designing a canister for forming a vessel connection for a metallic pressure vessel, comprising:
providing a vessel connection model of a vessel connection comprising:
   a wall portion corresponding to a portion of a vessel wall;
   a plurality of pipe extensions integrally formed with the wall portion;
defining a baseline canister model of a canister for forming a vessel connection according to the vessel connection model by hot isostatic pressing;
modifying the baseline canister model to remove or truncate a portion of the canister corresponding to at least one of the pipe extensions of the vessel connection, thereby providing a production canister model for forming a modified vessel connection having a removed or truncated pipe extension.

In a method according to the third or fourth aspect, the production canister model may be defined so that the removed or truncated pipe extension is closed at the wall portion.

The method may further comprise manufacturing a canister according to the production canister model, and forming the vessel connection by hot isostatic pressing using the canister.

According to a fifth aspect of the disclosure there is disclosed a non-transitory machine-readable medium comprising instructions configured to be executed by a processor to cause performance of a method in accordance with the third or the fourth aspect.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments of the disclosure will now be described by way of example only, with reference to the following drawings, in which:

FIG. 1 shows a schematic representation of a vessel for an industrial plant according to the prior art;

FIG. 2 is a schematic plan view of an example industrial plant layout according to an embodiment of the present disclosure;

FIG. 3 is a schematic perspective view of pipework between two vessels of the example industrial plant;

FIG. 4 is a schematic perspective view of an example vessel connection for a vessel;

FIG. 5 is a schematic perspective view of the vessel connection of FIG. 4 installed in a vessel wall;

FIG. 6 is a schematic perspective view of an example vessel connection;

FIG. 7 provides schematic cross-sectional views of two example vessels;

FIG. 8 is a schematic cross-sectional view of a canister for forming an example vessel connection;

FIGS. 9 and 10 are schematic cross-sectional views of modified canisters for forming a modified vessel connection;

FIGS. 11 and 12 are methods of manufacturing a vessel connection; and

FIG. 13 schematically shows a machine readable medium and a processor.

### DETAILED DESCRIPTION

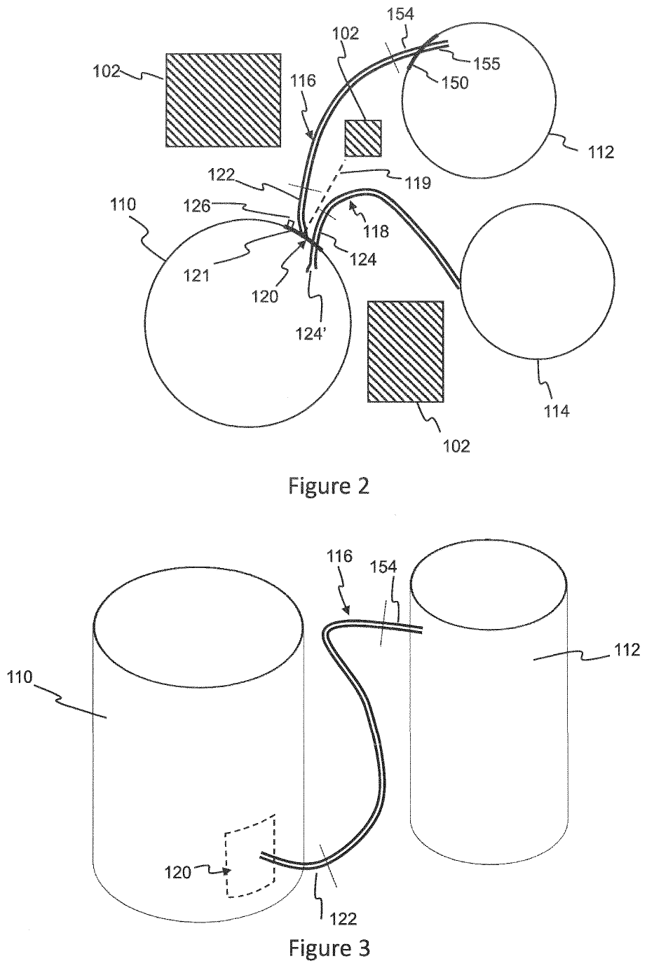

FIG. 2 shows an example industrial plant layout in which a main vessel 110 is fluidically connected to two auxiliary vessels 112, 114 by respective pipes 116, 118.

The main vessel 110 is cylindrical with a flat base and a hemi-spherical upper wall, and the auxiliary vessels have a similar shape. In other examples the vessels may be of any suitable shape and different shapes from one another.

Between the vessels in the industrial plant there are a variety of obstacles 102, such as ancillary equipment. Such obstacles 102 may limit the various routes that may be available for connecting pipes between the vessels.

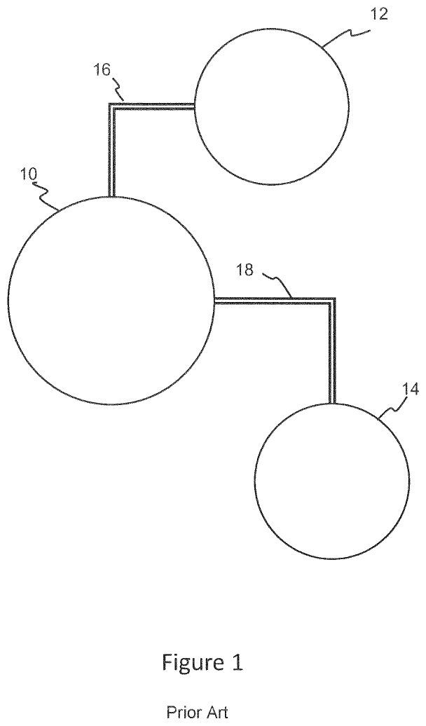

In this example, the pipes 116, 118 that connect the main vessel 110 to the auxiliary vessels 112, 114 extend along convoluted pathways that describe a space curve (i.e. a curve in three dimensions), and specifically a skew curve (i.e. a curve that does not lie in any single plane). In contrast to the plant layout depicted in FIG. 1, the pipes 116, 118 extend along non-linear pathways. The pipes 116, 118 may take any form as may be suitable to extend between the vessels, considering the obstacles and other constraints that may be specified in a plant layout. Such constraints may include, for example, a minimum clearance (e.g. for servicing) between pipes and/or between a pipe and a vessel; a minimum radius of curvature (e.g. a radius of curvature to the centreline of the pipe which is at least 3 times the diameter of the pipe).

By specifying a minimum clearance between the pipes and/or between any pipe and a vessel, access provision for servicing (e.g. with bulky tools, personnel or equipment) may be ensured. A minimum clearance may be specified at points of a pipe (e.g. joints of pipe sections or other maintenance/inspection sites), along portions of the pipe (e.g. an intermediate section extending between offset points along the pipe, the offset points being a predetermined distance away from a vessel such as 5 pipe diameters, pipe diameters), or along the full extent of the pipe.

By specifying a minimum radius of curvature along the pipe, high-curvature bends may be avoided. High curvature bends, such as mitre joints as an extreme example, provide stress concentrations in pipework.

In a compact plant layout, or one with a relatively high density of equipment, the flexibility to provide connecting pipes that describe three dimensional curves enable pipes to comply with such constraints as exemplified above, with example outcomes including: pipes which follow the profile of a vessel; highly convoluted pipe pathways to avoid equipment with no or a minimum number of connections between pipe sections; pipes which extend from vessels along directions which are oblique to local normal direction of the vessel wall; pipes that extend away from a vessel along a common direction (e.g. parallel lines or curves) before diverging (thereby reducing heat losses and limiting the space claim close to the vessel), pipes including a bifurcation from a pipe section that extends from a vessel to multiple pipe branches, and pipes that may be inter-woven with each other (e.g. one pipe at least partially wrapping around another before diverging from the pipe to extend to a different destination, which may reduce heat losses).

In this example, the pipes 116, 118 extending between the main vessel 110 and the auxiliary vessels 112, 114 are coupled to the main vessel 110 by way of a vessel connection 120.

The vessel connection 120 comprises a wall portion 121 which is configured to cooperate with a main body of the vessel 110 to form a portion of a wall of the vessel 110 when assembled with the main body (e.g. to fit in a corresponding opening of the main body of the vessel 110 to close the vessel), and first and second pipe extensions 122, 124 which are integrally formed with the wall portion 121. The first and second pipe extensions 122, 124 are respectively configured to form part of the first pipe 116 extending between the main vessel 110 and the first auxiliary vessel 112, and the second pipe 118 extending between the main vessel 110 and the second auxiliary vessel 112. A boundary between each pipe extension 122, 124 and a further pipe section which together define the respective pipe 116, 118 is shown in dashed lines in FIG. 2.

Vessel connections as disclosed herein may have one pipe extension or a plurality of pipe extensions. For example, the opposing end of the pipe 116 extending between the main vessel 110 and the first auxiliary vessel 112 is defined by a pipe extension 154 integrally formed with a wall portion 150 to provide a vessel connection at the first auxiliary vessel 112 comprising a single pipe extension 154. An intermediate pipe section is attached to and extends between the vessel connections at either end.

An external portion of a pipe extension as disclosed herein may be of any suitable length. For example, it may have a length equivalent to at least three multiples of the pipe diameter, or five multiples of the pipe diameter, or more.

In this example, the vessel connection 120 that couples with the main vessel 120 comprises two different kinds of pipe extensions. The first pipe extension 122 that forms part of the pipe 116 to the first auxiliary vessel 112 extends from an external surface of the wall portion 121 outwardly along a pathway that describes a three-dimensional curve, terminating at an end which is configured to attach to the intermediate pipe section. The second pipe extension 124 has both an external portion similar to the pipe extension of the first pipe extension 122, and additionally comprises an internal portion 124′ that extends inwardly from an interior surface of the wall portion 121.

The interior portion 124′ is configured to extend from a junction with the wall portion into the interior of the vessel 110. In this particular example the internal portion 124′ has a cross-sectional profile (i.e. normal to the pathway along which it extends) which expands as it extends away from the junction. This may provide an advantageous configuration of an opening of the interior portion 124′, for example for improved inlet flow conditions if a fluid flow is to leave the vessel via the pipe 116, or for improved outlet conditions (e.g. reduced flow rate at the outlet relative to an opening of smaller diameter). If the conventional method of attaching a pipe to a vessel is considered (i.e. by welding/bolting a pipe to the wall of the vessel and forming an opening in the wall), it will be readily appreciated that conventional methods do not permit the provision of an internal portion of a pipe extension as it could not be inserted through the vessel wall, and further would not permit an internal portion of a pipe extension to be provided which has an expanding cross-section on the interior side of the vessel, since the expanded portion could not be inserted or withdrawn through a hole in the vessel wall which may then form a junction with a more narrow portion of the pipe.

As shown in FIG. 2, each of the pipe extensions 122, 124 extend from the vessel connection 120 along a direction which is oblique relative to a normal direction 119 of the wall portion 121 at the junction with the wall portion. This is in contrast to conventional attachments of pipes to vessels, which extend along directions normal to the vessel. By permitting and configuring a pipe extension to extend from a vessel and vessel connection along a direction oblique with respect to the normal, the pipe extension and the pipe of which it forms a part may be oriented in a manner suitable for the plant layout, rather than being constrained to limited orientation for connection to the vessel.

The vessel connection 120 further comprises an instrumentation port 126. The instrumentation port comprises a mount for a sensor. In this example, the mount is in the form of a housing extending outwardly from the external side of the wall portion 121 to define a sensor cavity configured to communicate with the interior of the vessel when the vessel connection 120 is installed with the main body of the vessel 110. In this example, the mount has an opening (not shown) at one end corresponding to an opening in the wall portion for communication between the sensor and the fluid in the vessel. In other examples, the mount may be closed from the interior of the vessel, for example if the mount is to be used with a sensor that does not rely on fluid contact, such as a vibration or acoustic sensor.

FIG. 3 shows the main vessel 110 and the first auxiliary vessel 112 of FIG. 2 with selected elements of the pipework and vessel connection shown for clarity, including the pipe 116 extending between the vessels and formed by the pipe extension 122 that is integrally formed with the wall portion 121, whereas other components are removed (e.g. the pipe 118 and associated pipe extension, the instrumentation port 126).

FIG. 3 illustrates that the pipe extension 122 of the vessel connection 120 extends along a pathway which describes a space curve, and in particular a skew curve as described above (i.e. a three dimensional curve which does not lie in any one plane), as does the intermediate pipe section extending between the pipe extension 122 of the vessel connection and the pipe extension coupled to the first auxiliary vessel 112.

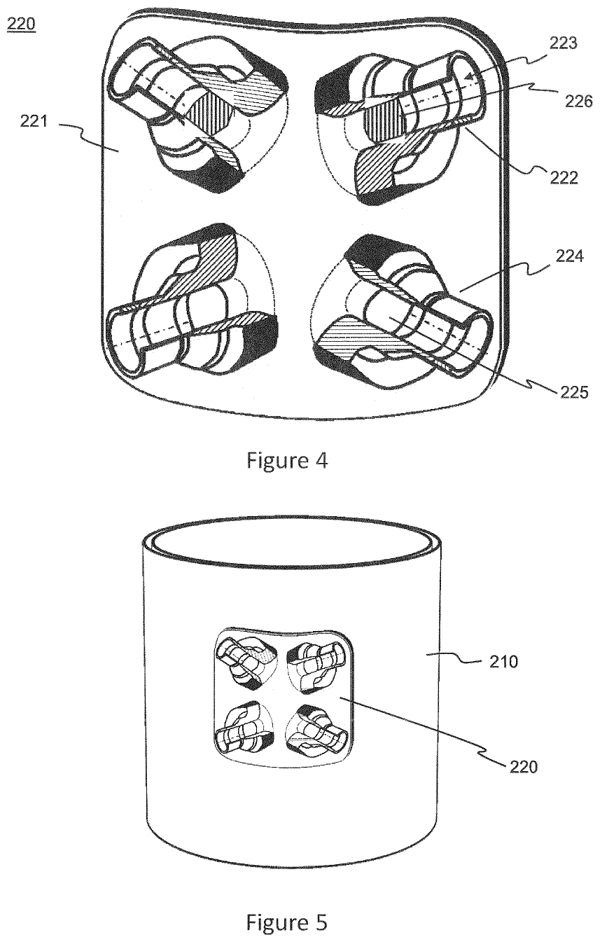

FIG. 4 schematically shows a further example vessel connection 220 similar to that described above with respect to FIG. 2, but comprising four pipe extensions 222, 224 integrally formed with a wall portion 221 and no instrumentation port. The wall portion 221 is configured to cooperate with a main body of a substantially cylindrical portion of a vessel (not shown). In this particular example, the pipe extensions 222, 224 extend along substantially linear pathways, but in variants of this example similar pipe extensions may describe a curve, such as a three-dimensional curve skew curve as described above.

As shown in FIG. 4, in this example each of the pipe extensions 222, 224 has a tapering pipe wall thickness which reduces (in stages) away from a junction between the respective pipe extension 222, 224 and the wall portion 221.

In this example, two of the four pipe extensions 222 are capped so as to prevent fluid communication between the interior of a vessel in which the vessel connection 220 is installed and a closed channel 223 of the pipe extension which terminates at the cap and does not extend through the wall portion 221. The capped pipe extensions 222 are each provided with a cap 226 at the junction between the respective pipe extension 222 and the wall portion 221.

The remaining two pipe extensions 224 each have open ports in the wall portion 221 at the junction where the wall portion 221 meets the pipe extension 224, such that there is an open channel 225 extending through the pipe extension 224 and the wall portion 221 for fluid communication between an interior of the respective vessel.

As will be described in further detail below, it may be desirable to provide a capped pipe extension in a vessel connection in order that a vessel connection (which may have a standard form or be an “off the shelf” connection) may be used even if a proper subset (i.e. not all) of the pipe extensions provided on the vessel connection are required for a particular installation.

As shown in FIG. 4, in this example the pipe extensions 222, 224 are relatively closely spaced together (i.e. with a relatively low clearance between them) where they intersect (i.e. join) the wall portion 221 at respective junctions, but extend away from the wall portion 221 along pathways which depart from one another so that they become increasingly spaced apart from one another away from the wall portion towards their distal ends (i.e. the ends farthest from the wall portion 221). In similar variants of the example, two or more but not necessarily all pipe extensions of a vessel connection may depart from one another in this way.

By configuring the pipe extensions to have an increasing clearance relative to one another away from the wall portion, it becomes possible to provide a relatively compact vessel connection which may be coupled to a main body of a vessel at a compact opening of the vessel, necessitating a relatively short join line between the two (e.g. for welding). By integrally forming the pipe extensions 222, 224 together with the wall portion 221, there is typically no need to provide a clearance suitable for tool or equipment access at the junctions between the pipe extensions 222, 224 and the wall portion as may otherwise be required with more conventional attachments (e.g. for welding, bolting, servicing). Moreover, since the pipe extensions have an increasing clearance relative to one another at increasing distance from the wall portion 221, a relatively higher clearance is provided towards the distal end of the pipe extensions 222, 224 as may be required for providing tool access for attaching, detaching and servicing a connection between a distal end of a pipe extension and an attached section of pipe.

FIG. 5 schematically shows the example vessel connection 220 installed with a main body of a vessel 210 to close the vessel 210.

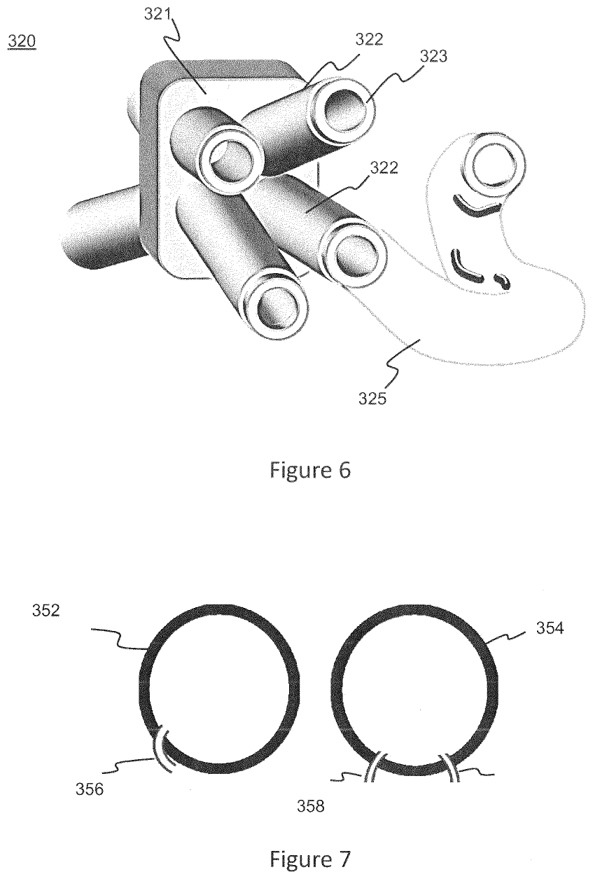

FIG. 6 schematically shows a further example of a vessel connection 300 which is similar to the vessel connections 320 described above with respect to FIG. 4, but differs in that the pipe extensions are substantially linearly extending and have both internal and external portions (as described above with respect to the vessel connection 120 of FIG. 2).

The vessel connection 300 comprises a wall portion 321 which in this example is substantially planar and is configured to fit within a corresponding opening of a main body of a vessel (not shown) as described above. There are four pipe extensions 322, each pipe extension having an external portion (all visible in FIG. 6) and an internal portion (extending from the reverse side of the wall portion 321 as shown in FIG. 6). At least one of the internal portions extend along a different linear direction to the respective external portion, such that the flow changes direction as it passes through the wall portion. As described above with respect to the vessel connection 220 of FIG. 4, the pipe extensions 322 have a clearance relative to one another that increases along the lengths of the pipe extensions from their respective junctions with the wall portion 321 towards their respective distal ends 323, which may facilitate access for tools and servicing equipment where the pipe extensions may connect with further pipe sections.

As with other examples described herein, the pipe extensions 332 are integrally formed with the wall portion 321.

For illustrative purposes, a convoluted pipe extension 325 is shown extending form one of the pipe extension 322. The pipe extension extends along a pathway which describes a three-dimensional curve, in particular a skew curve which does not lie in any plane. In this particular example, the curve may be described as serpentine. Other example forms of curve for a pipe section pathway may include spiral or helical.

FIG. 7 illustrates further example forms of pipe extension as may be applied to variants of any of the examples disclosed herein. FIG. 7 illustrates two example vessels 352, 354 in plan view cross-section. The first vessel 352 has a single vessel connection provided with a single pipe extension 356 having both internal and external portions so that a channel is defined along the pipe extension and through a respective wall portion of the vessel connection by which the pipe extension is connected to the vessel 352. The pipe extension 356 is curved as it extends from the interior of the vessel towards the wall portion of the vessel connection, and in this example is also curved as it extends externally from the junction with the wall portion such that it curves to follow a circular profile of the vessel wall. This may provide for a particularly compact arrangement of a pipe around a vessel, without requiring mitre bends or a succession of obtuse-angle bends to fit around the vessel.

The second vessel 354 has a double vessel connection which is provided with two pipe extensions 358 each having both internal and external portions so that a channel is defined along the respective pipe extension and through a respective wall portion of the vessel connection by which the pipe extension is connected to the vessel 354. In this particular example, each pipe extension 358 is substantially aligned with a local normal direction of the vessel wall at its junction with the vessel wall, but is curved so as to extend externally from the junction with the wall portion to depart from the local normal direction. In this particular example, the two pipe extensions mirror one another such that they curve to become substantially parallel with one another and with a normal direction of the vessel local to a midpoint between the junctions between the curves. Such an arrangement may be suitable, for example, when it is desired to have two laterally adjacent pipes that extend from a vessel along parallel directions but are to have a substantial clearance relative to one another (e.g. for maintenance or servicing).

As with other examples described herein, the pipe extensions 356, 358 may be integrally formed with respective wall portions configured to couple to the respective vessels, to thereby provide a vessel connection.

Each of the example vessel connections described herein with respect to FIGS. 2 to 7 are formed by hot isostatic pressing. A suitable hot isostatic pressing process involves:
manufacturing a canister corresponding to the shape of the vessel connection and configured to receive a metal powder;
filling the canister with metal powder such as steel (e.g. a low carbon, high toughness pressure bearing steel, which may have internal corrosion resistant cladding, or austenitic stainless steel, or a corrosion resistant nickel alloy) XX;
compressing the canister and heating it to an elevated temperature (e.g. a temperature sufficient for the material to plasticise and diffusion bond, but not to cause grain coarsening), for example by pressurising a chamber in which the canister is disposed with an inert gas such as argon;
allowing the canister to deform under pressure to consolidate the metal powder to form the vessel connection.

It may be complex to design a suitable canister, depending on the geometric complexity of an article to be formed by hot isostatic pressing.

Moreover, structural validation of a vessel connection may be a lengthy process which may involve simulation testing (e.g. using finite element analysis) and/or physical testing of a vessel connection.

The inventors consider there to be benefits in providing one or more baseline designs for vessel connections, which may each be used in a variety of different ways for different vessels and plant layouts.

For example, a multi-pipe vessel connection (e.g. a vessel connection having four pipe extensions) may be designed with a baseline geometry which can be validated (e.g. by simulation and/or physical testing) as complying to structural requirements. In some installations, only a proper subset (i.e. less than all) of the pipe extensions may be required. The vessel geometry may nevertheless be installed as originally designed, with one or more of the pipe extensions capped to prevent escape of fluid.

A vessel connection may be pre-fabricated with one or more pipe extensions capped, and the caps may be removed (e.g. by machining them out) for those pipe extensions which may be required.

Further, a baseline geometry for a vessel connection may be designed and validated as described above, and modified before manufacture according to specific requirements. For example, a multi-pipe vessel connection may be designed and validated, and a modified geometry may be generated in which one or more of the pipes is truncated or removed. It would be expected that such modifications would continue to meet structural performance requirements, since the wall portion of the vessel connection would be unchanged, and there would be fewer openings in the wall portion.

As will now be described in further detail, two main methods of providing such a modified vessel connection are disclosed herein.

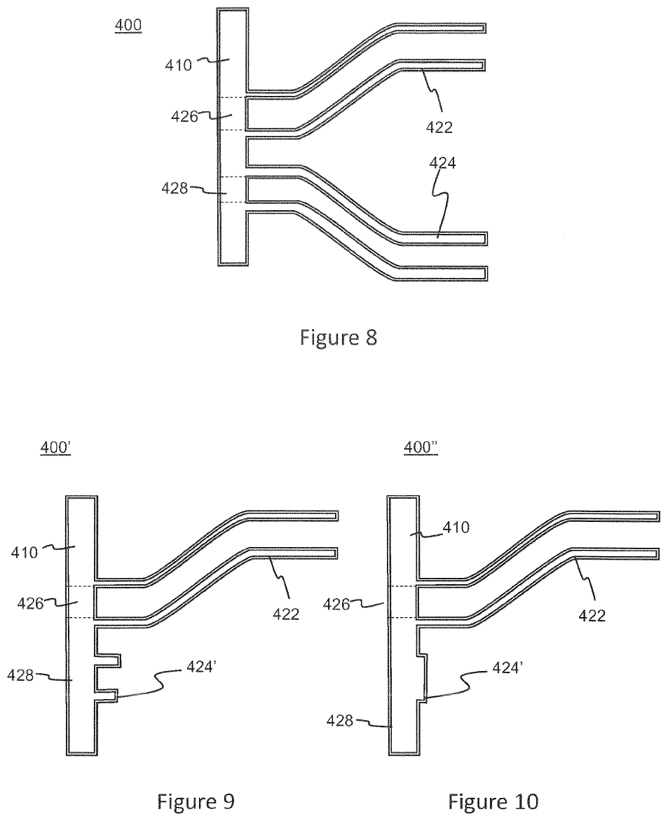

FIG. 8 schematically shows a cross sectional view of an example canister 400 for forming a vessel connection, such as a vessel connection as described herein with respect to any of FIGS. 2-7. The canister encloses a cavity which is configured to receive a metal powder, and is deformable under pressure so as to consolidate the powder. Accordingly, whilst the canister has a shape corresponding to a net shape of the vessel connection (i.e. a formed shape of the consolidated connection), the canister deforms to reach that that net shape during hot isostatic pressing. This deformation may be predicted, for example using finite element analysis.

The example canister 400 of FIG. 8 comprises a wall region 410 corresponding to a wall portion of a baseline vessel connection, and a plurality of pipe extension regions 422, 424 (two shown) corresponding to respective pipe extensions of the baseline vessel connection. The geometry of the canister as shown in solid lines at intersecting junctions of the pipe extension regions with the wall region defines a powder-receiving cavity which extends across the wall at the junction, such that a cap would be formed at the junction between each of the respective pipe sections and the wall portion (as indicated by regions 426, 428). However, in variants of this example, the canister may have a boundary at this location such that one or more channels are formed in the vessel connection which extends through a respective one of the pipe extensions and the wall portion (as indicated by dashed lines at locations 426, 428). In further examples, a pre-formed element formed of a different material to the metal powder to be received in the canister may be provided at the cap regions (i.e. in the regions of the cavity corresponding to the caps), and such a pre-formed element may be removed after hot isostatic pressing, for example by etching or machining away.

FIG. 9 shows a first example of a modified canister 400′ which differs from the canister 400 described above with respect to FIG. 8 in that the pipe extension region 424′ corresponding to one of the pipe extensions of the baseline vessel connection is truncated, such that a truncated form of the pipe extension would be formed. As indicated at reference numeral 428, the modified canister 400′ describes a cavity which would receive powder at the location of the junction between the wall portion and the truncated pipe extension such that a cap is formed at the junction, thereby preventing fluid flow through the truncated pipe extension.

FIG. 10 shows a second example of a modified canister 400″ which differs from the modified canister 400′ described above with respect to FIG. 9 in that, instead of one of the pipe extension regions being truncated, it is removed. As indicated in FIG. 10, the modification of the canister to remove the pipe extension region may nevertheless leave a raised portion which protrudes slightly from the profile of the wall region 410.

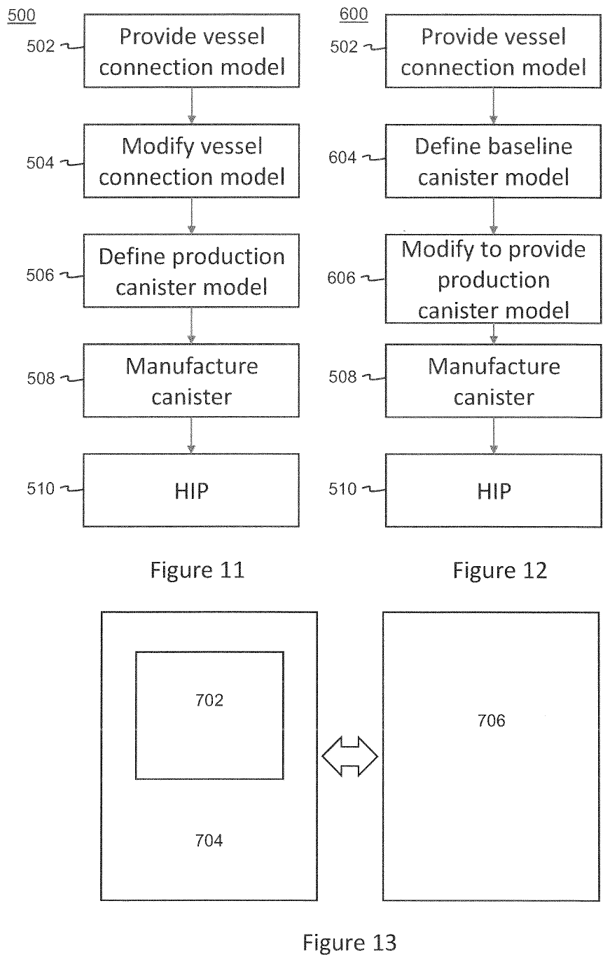

Example methods of designing a canister and manufacturing a vessel connection are shown in the flow diagrams of FIGS. 11 and 12. The steps of the method relating to design may be computer-implemented.

A first example method 500 is described with respect to FIG. 11. In block 502, a digital model of a vessel connection is provided, which is referred to as a vessel connection model. For example, the model may be a CAD geometry of a vessel connection comprising multiple pipe extensions as described herein. The model may be provided by loading it from a memory (i.e. it may be predefined), or by constructing it (e.g. on a computer). The model may correspond to a vessel connection design which has already been structurally validated (e.g. by simulation or physical testing) for a range of operating conditions or is structurally validated before the ensuing steps described below.

In block 504, the vessel connection model is modified to truncate or remove a pipe extension of the vessel connection defined by the model, as described above. The truncation or removal may be done by a user modifying geometry definitions of a CAD geometry, or by a selection of sub-components of the vessel connection model and deleting them from the model, for example.

In block 506, a production canister model is defined, which defines a geometry for a canister for the manufacture of a vessel connection according to the modified vessel connection model. As mentioned above, the cavity defined within the canister may correspond to the desired shape of the vessel connection, and may be configured to deform to the net shape of the vessel connection. The term “production” is used to indicate that the production canister is intended to be manufactured in order to form a vessel connection.

In block 508, a canister according to the production canister model is manufactured. For example, the canister may be manufactured by joining portions of sheet metal, as is known in the art.

In block 510, a vessel connection is manufactured using the canister by filling the canister with metal powder, and subjecting the canister to elevated pressure and temperature to cause the canister to deform and consolidate the metal powder. The formed vessel connection may then be removed from the canister, and any finishing (e.g. by machining out caps or other unnecessary features) may be performed.

The second example method 600 shown in FIG. 12 differs from the method 500 of FIG. 11 in that a baseline canister model is modified to provide the modified vessel connection, rather than the modifying the underlying geometry of the vessel connection itself.

In block 502, a vessel connection model is provided as disclosed above.

In block 604, a baseline canister model is defined, which defines a geometry for a canister for the manufacture of a vessel connection according to the vessel connection model. As mentioned above, the cavity defined within the canister may correspond to the desired shape of the vessel connection, and may be configured to deform to the net shape of the vessel connection during hot isostatic pressing.

In block 606, the baseline canister model is modified to provide a different production canister model corresponding to a modified vessel connection in which one or more of the pipe extensions is removed or truncated. For example, the baseline canister model is modified to remove or truncate one or more pipe extension regions corresponding to one or more pipe extensions of the vessel connection, as described above with respect to FIG. 9 or 10.

In blocks 508 and 510, a canister corresponding to the production canister model is manufactured, and a vessel connection according to the production canister model is formed using the canister using hot isostatic pressing, as described above with respect to FIG. 11.

As indicated above, the design steps of the above described methods may be implemented on a computer, for example they may be conducted on a computer based on machine-readable instructions encoded on a non-transitory machine-readable medium, including instructions which when executed by a processor cause performance of the method as described with respect to blocks 502, 504, 506 of the method 500, or blocks 502, 604, 606 of the method 600. An example machine-readable medium is a computer memory such as a hard disk, a removable disk, or a remote disc (e.g. located on an internet server). FIG. 13 shows a machine-readable medium 704 such as a computer memory including instructions 702 configured to be executed by a processor 706 to cause performance of such a design method as described above with respect to FIG. 11 or 12.

The disclosure extends to variants of the examples disclosed herein which combine features from the different examples. In particular, any of the components disclosed herein (e.g. example vessel connections, vessels and pipes) may incorporate any of the features of the other example components disclosed herein, except such features as are mutually exclusive.

1. A vessel connection for a metallic pressure vessel comprising:
a wall portion configured to form a portion of a vessel wall;
a pipe extension integrally formed with the wall portion; and
a channel through the wall and the pipe extension.

2. The vessel connection according to claim 1, wherein the pipe extension extends from the wall portion along a direction which is oblique relative to a normal direction of the wall portion.

3. The vessel connection according to claim 1, wherein the wall portion is substantially planar or is configured to form a portion of a cylindrical, domed, or conical part of a vessel.

4. The vessel connection according to claim 1, wherein the pipe extension has a convoluted profile such that a central path of the pipe extension along which it extends describes a three-dimensional curve.

5. The vessel connection according to claim 1, wherein the wall portion has an internal side corresponding to an interior of the vessel and an opposing external side corresponding to an exterior of the vessel, wherein the pipe extension extends from the external side by an amount equal to at least five times the diameter of the pipe extension at a junction with the wall portion.

6. The vessel connection according to claim 1, wherein the wall portion has an internal side corresponding to an interior of the vessel and an opposing external side corresponding to an exterior of the vessel;
wherein the pipe extension comprises an external portion extending from the external side and an internal portion extending from the internal side; and
wherein the internal portion meets the wall portion at a junction, and wherein a cross-section of the internal portion expands away from the wall.

7. The vessel connection according to claim 1, further comprising an instrumentation port formed in the wall portion for insertion of a sensor into the vessel.

8. The vessel connection according to claim 1, wherein there is a plurality of pipe extensions, and one or more channels extending through one or more respective pipe extensions.

9. The vessel connection according to claim 8, wherein the wall portion has an external side corresponding to an exterior of the vessel;
wherein each of the pipe extensions extend from a junction with an external side of the wall portion to a distal end for attachment to a separate pipe or vessel;
wherein a spacing between two pipe extensions increases as they extend away from the wall portion, such that the two pipe extensions are spaced apart by a greater distance at their distance ends than at the respective junctions with the wall portion.

10. The vessel connection according to claim 8, wherein at least one of the pipe extensions is closed at a respective junction with the wall portion to prevent fluid flow through the wall portion via the pipe extension.

11. A vessel installation comprising:
a vessel having a wall comprising a vessel connection in accordance with claim 1.

12. The vessel installation according to claim 11, wherein the vessel connection is in accordance with claim 10, and wherein:
a first pipe extension of the vessel connection is open at a respective junction with the wall portion for fluid communication between the vessel and a second component of the installation;
a second pipe extension of the vessel connection is closed at the respective junction with the wall portion to prevent fluid communication along the second pipe extension.

13. A method of designing a canister for forming a vessel connection for a metallic pressure vessel, comprising:
providing a vessel connection model defining a vessel connection comprising: a wall portion corresponding to a portion of a vessel wall;
a plurality of pipe extensions integrally formed with the wall portion; modifying the vessel connection model to remove or truncate at least one of the pipe extensions from the vessel connection, thereby providing a modified vessel connection model defining a modified vessel connection;
defining a production canister model of a canister for forming the modified vessel connection by hot isostatic pressing.

14. The method of claim 13,
wherein defining a production canister model comprises:
defining a baseline canister model of a canister for forming a vessel connection according to the vessel connection model by hot isostatic pressing;
modifying the baseline canister model to remove or truncate a portion of the canister corresponding to at least one of the pipe extensions of the vessel connection, thereby providing a production canister model for forming a modified vessel connection having a removed or truncated pipe extension.

15. The method according to claim 13, wherein the production canister model is defined so that the removed or truncated pipe extension is closed at the wall portion.

16. The method according to claim 13, further comprising manufacturing a canister according to the production canister model, and forming the vessel connection by hot isostatic pressing using the canister.

17. A non-transitory machine-readable medium comprising instructions configured to be executed by a processor to cause performance of a method in accordance with claim 13.
